(19) United States
(12) Patent Application Publication
(10) Pub. No.: US 2025/0123815 A1
(43) Pub. Date: Apr. 17, 2025

(54) METHOD AND SYSTEM FOR VISUALLY INSPECTING COMPUTATIONAL GEOMETRY CODE

(71) Applicant: HCL Technologies Limited, New Delhi (IN)

(72) Inventors: TATHAGATA CHAKRABORTY, Pune (IN); PRASAD PRAKASH WAIKAR, Pune (IN); ABHIJIT KUMTHEKAR, Pune (IN); NITIN UMAP, Pune (IN)

(21) Appl. No.: 18/609,499

(22) Filed: Mar. 19, 2024

(30) Foreign Application Priority Data
Oct. 12, 2023 (IN) 202311068913

(51) Int. Cl. G06F 8/34

(52) U.S. Cl. CPC G06F 8/34

(57) ABSTRACT

The disclosure relates to a method and system of visually inspecting computational geometry code. The method may include converting a legacy data-structure for a geometric object into an associated neutral data-structure, wherein the neutral data-structure is adaptable to be visually rendered. The method may further include transferring the neutral data-structure to an inter-process communication channel, and rendering the geometric object corresponding to the neutral data-structure, upon fetching the neutral data-structure from the inter-process communication channel.

### Technical Field

This disclosure relates generally to visual inspection of codes, and in particular to a method and a system for visually inspecting computational geometry code during a debugging session.

### Background

Over a period of time, codes of programming languages eventually rots and becomes increasingly unmaintainable. This is especially true for scientific code since it is often difficult to name the intermediate variables and functions to accurately reflect their purpose. Ironically, giving descriptive names to variables and functions in scientific code can often make the code more difficult for a human to parse and understand. Further, scientific code that is in production often contains numerous heuristics to handle various edge cases and numerical errors, and is peppered with hacks to improve performance. As such, the scientific code may be almost impossible to understand. In some scientific applications like CAD/CAM, data being manipulated in code is geometry data which can often be visualized. However, not all the intermediate data can be easily visualized in the end-user CAD/CAM applications, especially when the application is actively being debugged using a debugger.

Therefore, there is a need for solutions that enable dynamic watching of geometric entities being manipulated in legacy code and playback of the geometric changes, via a separate visualization application.

### SUMMARY

In an embodiment, a method of visually inspecting computational geometry code is disclosed. The method may include converting a legacy data-structure for a geometric object into an associated neutral data-structure. The neutral data-structure is adaptable to be visually rendered. The method may further include transferring the neutral data-structure to an inter-process communication channel, and rendering the geometric object corresponding to the neutral data-structure, upon fetching the neutral data-structure from the inter-process communication channel.

In another embodiment, a system for visually inspecting computational geometry code is disclosed. The system includes a processor and a memory. The memory stores a plurality of processor-executable instructions, which upon execution, cause the processor to convert a legacy data-structure for a geometric object into an associated neutral data-structure. The neutral data-structure is adaptable to be visually rendered. The plurality of processor-executable instructions, upon execution, further cause the processor to transfer the neutral data-structure to an inter-process communication channel, and render the geometric object corresponding to the neutral data-structure, upon fetching the neutral data-structure from the inter-process communication channel.

### BRIEF DESCRIPTION OF THE DRAWINGS

The accompanying drawings, which are incorporated in and constitute a part of this disclosure, illustrate exemplary embodiments and, together with the description, serve to explain the disclosed principles.

FIG. 1 is a block diagram of an exemplary system for visually inspecting computational geometry code, in accordance with some embodiments of the present disclosure.

FIG. 2 is a block diagram of an overall architecture of the system, in accordance with an embodiment of the present disclosure.

FIG. 3 is a functional block diagram of the code inspecting device showing one or more modules, in accordance with some embodiments.

FIG. 4 depicts an illustrative example of a visualization window of the visualization application, in accordance with some embodiments.

FIG. 5 depicts an illustrative example of a visualization window of the visualization application with a graphical timeline, in accordance with some embodiments.

FIG. 6 depicts an illustrative example of a visualization window of the visualization application with queries and tags on the visualization window, in accordance with some embodiments.

FIG. 7 illustrates a flowchart of a method of visually inspecting computational geometry code, in accordance with some embodiments.

FIG. 8 illustrates a flowchart of a method of computing the hash value of each of the neutral data-structure, in accordance with some embodiments.

FIG. 9 illustrates a flowchart of a method of rendering the geometric object based on change in hash value, in accordance with some embodiments.

FIG. 10 is an exemplary computing system that may be employed to implement processing functionality for various embodiments.

### DETAILED DESCRIPTION

Exemplary embodiments are described with reference to the accompanying drawings. Wherever convenient, the same reference numbers are used throughout the drawings to refer to the same or like parts. While examples and features of disclosed principles are described herein, modifications, adaptations, and other implementations are possible without departing from the spirit and scope of the disclosed embodiments. It is intended that the following detailed description be considered as exemplary only, with the true scope and spirit being indicated by the following claims. Additional illustrative embodiments are listed below.

The present subject relates to a method and system for dynamically watching geometric entities being manipulated in legacy code and playing back the geometric changes in a separate visualization application. The techniques of the present subject matter can be implemented even in situations where the programming language, compiler, and debugger do not have built-in mechanisms for such visualization and analysis, and where these tools cannot also be easily extended to include such support. Further, the techniques of the present subject matter require minimal or no modification and instrumentation of the legacy code-base, avoiding the tediousness of current approaches to debugging such code. Furthermore, the data in the visualization application can be queried for geometric information. The ability to visualize a layered rendering of multiple geometric entities being manipulated in code and the ability to play them back in time can be of great help in understanding legacy geometry related code and is a useful aid when developing new computational geometric algorithm.

As will be appreciated by those skilled in the art, most CAD/CAM/CAE (also referred to as CAx) applications that are currently in use were developed incrementally over the last three to four decades. These applications may have very large and rotting code bases that are becoming increasingly difficult to understand. Further, the existing legacy code base needs regular maintenance. Computational geometry algorithms form the core and the most complex part of all CAx applications. Most such algorithms are already complicated in their theoretical form and can be difficult to understand and implement robustly. However, in production code one has to handle various edge cases and issues due to numerical error propagation and other concerns which makes the actual implementation of such algorithms even more complex. Understanding the overall architecture of such systems can be important and here static and dynamic analysis of the functions and objects in the system can be useful. However, often the network of calls and dependencies that result from such analysis is too entangled.

As such, the present subject matter provides for visualizing geometric objects during debugging of legacy code-base without having to modify or instrument the code. The techniques of the present subject matter are largely agnostic to the programming language, compiler, debugger, and platform in which the legacy application resides and works.

Visualization can play an important role in program understanding and debugging. In many industries, code-base of large applications are becoming old and therefore unmaintainable, with the people who originally wrote these programs no longer there to aid in their understanding. Visualization can potentially help with the understanding and maintenance of such code-base. However, existing visualization techniques are constrained in several different ways. For visualization at the algorithm level for algorithm understanding one must tailor the visualization for the particular algorithm. This requires tight integration with the algorithm code and a significant amount of effort. Further, techniques that depend upon a particular language, framework, or code editor are although useful for designing new applications; however, these techniques can't be used for understanding legacy code where such understanding is required the most. Moreover, techniques that can statically analyze the code or dynamically analyze the runtime behavior of the program can only give broad insights at the component level of the program but cannot help in understanding complex algorithms.

An objective of the present subject matter is to understand the behavior in enough detail to be able to make correct extensions to the algorithm and fix bugs in the code. Secondary goals are to ref-actor the code to enhance readability and, less frequently, to rewrite the whole algorithm using a better or modern approach.

Currently developers are forced to insert code to dump the geometric entities to files which then have to be opened manually in a separate application for viewing. The whole process can be tedious because every time the developer needs to inspect a certain object at a certain point in code he or she has to add code to dump the state of the object at that point. This also involves compiling the code again and stepping through the code again to reach that particular point in code. Once the debugging session is over and the problem has hopefully been resolved, it can be equally difficult to remove all the debug dump code that is now littered throughout the code-base. However, this is the only approach that is available to developers today.

Algorithm animation would be of immense help in the understanding of such computational geometry code. A primary reason is that computational geometry creates and manipulates 2D and 3D data which are the primary types of data that we can easily visualize. Manually integrating animation code into legacy computational geometry code can however become very tedious since these code-base can easily span several millions of lines of code.

To this end, the present subject matter enables developers to visually inspect computational geometry code during debugging by adding the ability to ‘watch’ geometric entities and objects similar to how one can watch variables of standard data types in an integrated development environment.

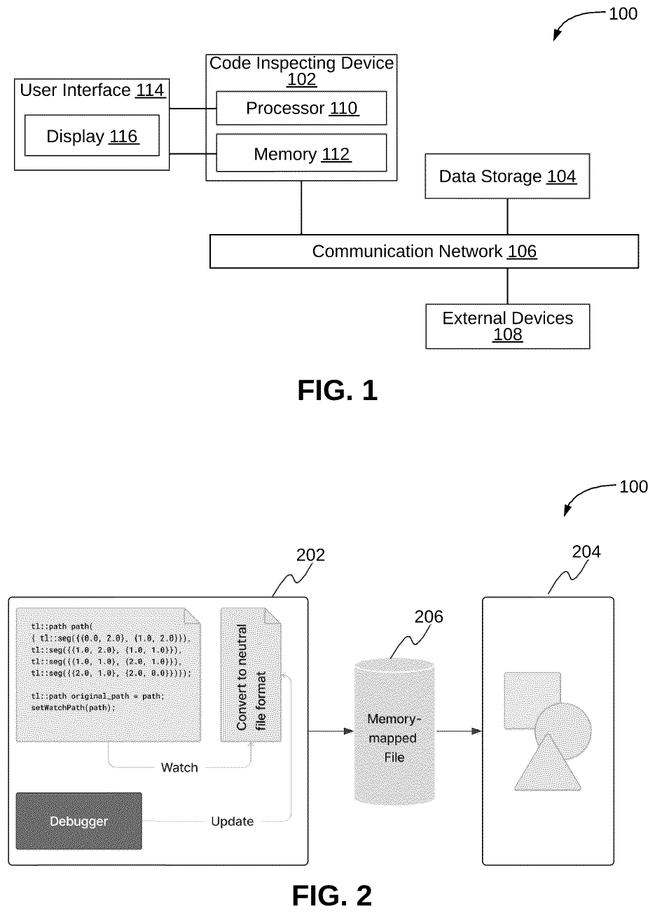

Referring now to FIG. 1, a block diagram of an exemplary system 100 for visually inspecting computational geometry code is illustrated, in accordance with some embodiments of the present disclosure. The system 100 may implement a code inspecting device 102. Further, the system 100 may include a data storage 104. In some embodiments, the data storage 104 may store the legacy data-structures for a geometric object. The code inspecting device 102 may be a computing device having data processing capability. In particular, the code inspecting device 102 may have the capability for visually inspecting computational geometry code. Examples of the code inspecting device 102 may include, but are not limited to a desktop, a laptop, a notebook, a netbook, a tablet, a smartphone, a mobile phone, an application server, a web server, or the like.

Additionally, the code inspecting device 102 may be communicatively coupled to an external device 108 for sending and receiving various data. Examples of the external device 108 may include, but are not limited to, a remote server, digital devices, and a computer system. The code inspecting device 102 may connect to the external device 108 over a communication network 106. The code inspecting device 102 may connect to external device 108 via a wired connection, for example via Universal Serial Bus (USB). A computing device, a smartphone, a mobile device, a laptop, a smartwatch, a personal digital assistant (PDA), an e-reader, and a tablet are all examples of external devices 108.

The code inspecting device 102 may be configured to perform one or more functionalities that may include converting a legacy data-structure for a geometric object into an associated neutral data-structure. The neutral data-structure may be adaptable to be visually rendered. The one or more functionalities may further include transferring the neutral data-structure to an inter-process communication channel and rendering the geometric object corresponding to the neutral data-structure, upon fetching the neutral data-structure from the inter-process communication channel.

To perform the above functionalities, the code inspecting device 102 may include a processor 110 and a memory 112. The memory 112 may be communicatively coupled to the processor 110. The memory 112 stores a plurality of instructions, which upon execution by the processor 110, cause the processor 110 to perform the above functionalities. The system 100 may further include a user interface 114 which may further implement a display 116. Examples may include, but are not limited to a display, keypad, microphone, audio speakers, vibrating motor, LED lights, etc. The user interface 114 may receive input from a user and also display an output of the computation performed by the code inspecting device 102.

Referring to FIG. 2, a block diagram of an overall architecture of the system 100 is illustrated, in accordance with an embodiment of the present disclosure. As shown in FIG. 2, the system 100 may include two components—an integrated development environment (IDE) 202 and a visualization application 204. The IDE 202 may include a function that converts legacy geometric data structures into a common format, watches for changes in the geometry objects, and writes the data into a memory-mapped file (or any other inter-process communication channel) 206. This function needs to be written once and included and compiled as a part of the legacy application that is being debugged. The visualization application 204 is an independent application that monitors for changes in the memory-mapped file 206, reads the geometric entities therein, and renders the geometric entities on screen. The visualization application 204 may be independent of the application being debugged. As such, the visualization application 204 may be developed and maintained separately. The legacy code for the most part needs no changes and need not be touched.

As will be appreciated, most code debugger applications and integrated development environments (IDEs) include the ability to watch and inspect data-types that are a standard part of the language. Composite data-types and simple data-types can be inspected; however, their inspection output values can only be visualized as text. In computational geometry, the geometric data-types like points, lines, polylines, planes and meshes have a non-ambiguous geometric visualization. As such, viewing data associated with these geometric entities as text provides very little information about their configurations and their relative positions and orientations. The debugger applications in some IDEs can be extended to handle and visualize custom data types. However, these debugger applications may be restricted to a particular development environment and to the facility that the environment provides for visualization. This challenge is further accentuated in case of legacy code, where the language, compiler and the environment in which the project can be built is rigid.

To this end, the present subject matter provides for a solution which is agnostic to the development language and environment (including the operating system being used) and only requires that the debugger application is able to invoke an arbitrary function in the code during debugging which most debuggers are capable of. When trying to understand and debug legacy code, it is important not to change the legacy code, since such changes can affect the performance and behavior of the code. The present subject matter does not require any changes to the existing code-base (including any time of runtime instrumentation) and only require the addition of two functions to the legacy code-base-one that converts the legacy geometric data structures to a neutral format that can be rendered by the visualization function and another function that continuously loops over the watched geometric entities and looks for changes in the geometric data.

The integration between the IDE 202, the visualization application 204, and the memory-mapped file 206 may be performed by the code inspecting device 102. To this end, the code inspecting device 102 may include one or more modules for performing the one or more functions, as is explained below.

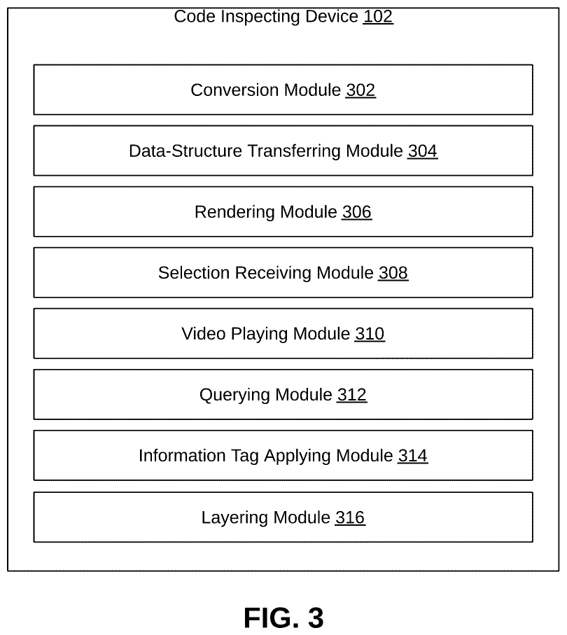

Referring now to FIG. 3, a block diagram of the code inspecting device 102 showing one or more modules is illustrated, in accordance with some embodiments. In some embodiments, the code inspecting device 102 may include a conversion module 302, a data-structure transferring module 304, and a rendering module 306. Additionally, in some embodiments, the code inspecting device 102 may further implement a selection receiving module 308, video playing module 310, querying module 312, and an information tag applying module 314.

The conversion module 302 may be configured to convert a legacy data-structure for a geometric object into an associated neutral data-structure. The neutral data-structure may be adaptable to be visually rendered. The conversion module 302 may convert the legacy data-structure for the geometric object into the associated neutral data-structure, using a conversion function.

In one embodiment, the conversion module 302 may convert the legacy data-structure for the geometric object periodically into the associated neutral data-structure, at a predefined time interval. By way of an example, the predefined time interval may be 1 second. In another embodiment, the conversion module 302 may convert the legacy data-structure into the associated neutral data-structure based on the user manipulating the code during the debugging session. To this end, the conversion module 302 may detect a user manipulating a code during a debugging session. Further, the conversion module 302 may convert the legacy data-structure for the geometric object into the associated neutral data-structure, upon detecting the user manipulating the code during the debugging session.

As will be appreciated, in a CAx application, the geometry data can be present in a variety of formats and data structures. Sometimes the same data can be present in the same function in slightly different forms depending on the ease with which each data-structure can be manipulated using some algorithm. Handling the visualization of all such data at the visualization application level can be cumbersome and may make the visualization application dependent on the codebase that is currently being debugged. Converting the geometry data into an application-neutral format ensures that the visualization application can be reused across different CAx applications. Such an arrangement and separation of concerns ensures that the visualization application can also be developed and maintained independently by a separate team and its development would no longer be tied to the development of the CAx application.

Most geometric data-structures can be converted into a neutral format in linear time. As such, a conversion function may be created (for example, by a team maintaining the CAx application) for each legacy data-structure that needs to be visualized during debugging. As will be understood, all such legacy data-structures may not need such conversion functions immediately. Depending upon which data-structures are the most important for debugging and code understanding, the list of data-structures can be prioritized for conversion and such conversion functions can be written over a period of time. The prioritization improves the richness of the debugging sessions with time.

The data-structure transferring module 304 may be configured to transfer the neutral data-structure to an inter-process communication channel. For example, the inter-process communication channel may be a memory-mapped file 206, as shown in FIG. 2.

Conversion of the data-structure to neutral format (although may allow for visualizing a geometric data-structure in the visualization application) only captures a single and instantaneous snapshot of the data during debugging. In order to track changes in the data, the developer debugging the application must then manually invoke the conversion function each time to visualize the changes. However, manually tracking the changes when the geometric data is changing frequently can become tedious. As such, the user may prefer to track changes to the geometry data automatically.

It should be noted that some modern languages and/or frameworks on top of them enable reactive programming. Such languages or frameworks offer the ability to track the states of objects easily and provide an event-driven model of programming. However, older languages like C/C++ in which most CAx applications are coded may not provide such an event-driven model. While there are now frameworks on top of languages like C/C++ that provide such functionalities; however, these frameworks are actually meant for new code that is being written. Therefore, it is impractical to convert large legacy code-base to use such frameworks. To support tracking changes in geometric data-structures, non-invasive techniques are required that do not require making changes to the existing code-base.

To this end, the conversion module 302 may track the changes of the objects being actively watched. For example, the conversion module 302 may track the changes by computing hash values of their neutral data-structures and using a timer function (typically set to trigger every second) to repeatedly convert the legacy data-structures into their neutral counterparts and compute their hash values. If the hash values are different, then the data-structure transferring module 304 may transfer (i.e. write) new data to the memory-mapped file (206) from where the visualization application may pick up and render the new data. Additionally, the data-structure transferring module 304 may store neutral data-structures at the inter-process communication channel, for a plurality of points in time from the timeline of the debugging session.

Further, in an embodiment, in order to compute the hash of geometric entities, the conversion module 302 may concatenate coordinates of the points and other parameters representing the geometric entity into a long string. The conversion module 302 may further compute a checksum value for the string, for example, using a Fast algorithm. For example, the Fast algorithm may be one of “MD5” and “Adler-32”. As will be appreciated, both these example Fast algorithms are linear time algorithms, using which the hash values can be computed relatively quickly. The conversion module 302 may further compute the hash value of the geometric object based on the checksum value for the string.

The rendering module 306 may be configured to render the geometric object corresponding to the neutral data-structure, upon fetching the neutral data-structure from the inter-process communication channel. In particular, the geometric object corresponding to the neutral data-structure may be rendered via a visualization application. In an embodiment, in order to render the geometric object corresponding to the neutral data-structure, the rendering module 306 may compute a hash value of each of the neutral data-structure received at the inter-process communication channel at different points in time, during a debugging session. The rendering module 306 may further compare a hash value of a latest neutral data-structure with a hash value of a previously stored neutral data-structure, and rendering the geometric object corresponding to the latest neutral data-structure, based on the comparison.

Further, based on the comparison, for the latest neutral data-structure, the rendering module 306 may render the geometric object corresponding to the previously stored data-structure, when the hash value of the latest neutral data-structure is same as the hash value of the previously stored neutral data-structure. However, when the hash value of the latest neutral data-structure is different from the hash value of the previously stored neutral data-structure, the rendering module 306 may update the geometric object corresponding to the latest neutral data-structure.

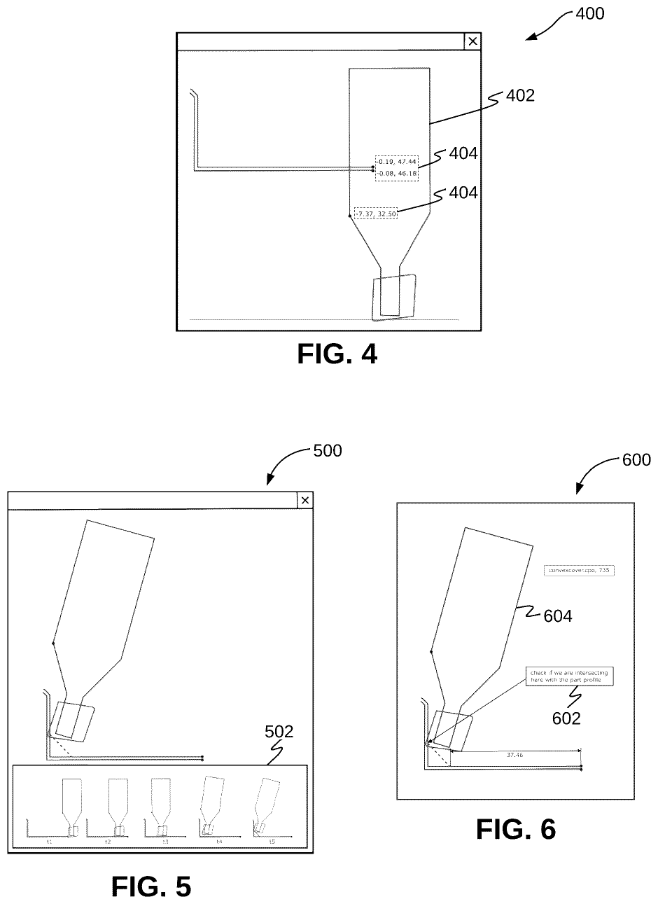

It should be noted that the visualization application may be an independent application that supports the rendering of all the geometric entities in their neutral format. The visualization application may run in a loop with a timer. Every time through the loop, the visualization application may read the data from the memory-mapped file. For all the geometric entities in the memory-mapped file, the visualization application may check if any hash value has changed since it last rendered the geometric entity. If the hash value has changed, then the rendering module 306 (i.e. the visualization application) may read the updated geometry data from the memory-mapped file and render the updated geometric entity. Otherwise, the rendering module 306 may render the entity from its own cached memory. FIG. 4 depicts an illustrative example of a visualization window 400 of the visualization application, in accordance with some embodiments. As shown in FIG. 4, the visualization window 400 includes a rendering of a geometric object 402 (corresponding to the neutral data-structure) along with some annotations (i.e. tags) 404.

It may be noted that since the visualization application is independent from the CAx application being debugged, the visualization application may be implemented in a different language and framework, preferably one that is modern and better suited for the requirements. Further, any existing visualization application may also be used if it has the required visualization functionality and if it can be extended using an add-on to read the data from the memory-mapped file. When a different network communication channel like a remote database is used, it may be even possible to use the visualization application on a separate machine.

As mentioned above, neutral data-structures may be stored at the inter-process communication channel, for a plurality of points in time from the timeline of the debugging session (by the data-structure transferring module 304). The selection receiving module 308 may be configured to receive, from a user, a selection of a target point-in-time from the timeline of the debugging session.

The video playing module 310 may be configured to play a video generated using the geometric objects associated with the neutral data-structures commencing from the target point-in-time from the timeline of the debugging session. During a debugging operation, as the developer steps through the code, the changes in the watched geometric objects may be automatically updated in the visualization application. This forward only visualization is very useful but for complex geometric objects the developer may want to pause the debugging process and step back through time in the visualization application to inspect in more detail the last few changes made to the geometric object. Therefore, to enable such stepping back in time, the visualization application may automatically maintain a history of all changes done to the geometric objects. The developer may choose to clear this history at any time if he or she wants to focus on only a particular section of the code in detail. This history can be made available in a variety of ways, for example, by including buttons to step back and forward in time. In another example, a slider may be included in the visualization application. In yet another example, snapshots of the time steps may be included in the visualization in a scrollable view on one side of the application.

FIG. 5 depicts an illustrative example of a visualization window 500 of the visualization application with a graphical timeline. As can be seen in FIG. 5, in an example implementation, the graphical timeline 502 can be displayed at the bottom of the visualization window (or along a left side or right side of the visualization window). As such, a user (i.e. a debugger) may select a point in time from the timeline to move through the graphical timeline 502.

The querying module 312 may be configured to receive a query with respect to one of: a selected individual geometric object or a selected sub-entity associated with the individual geometric object. The visualization application implemented as a separate independent application for visualizing the geometric data (as against integrating such visualization inside an integrated development environment (IDE)) allows for the visualization application to implement complex functionality which might otherwise be difficult to implement inside the IDE. For example, the independent visualization application allows for performing various queries on the geometric data that is currently being visualized. The visualization application may therefore implement an ability to select individual geometric objects and their sub-entities and query them for information like position, length, direction etc.

FIG. 6 depicts an illustrative example of a visualization window 600 of the visualization application with queries and tags on the visualization window 600. As shown in FIG. 6, a query 602 (“check we are intersecting here with the part profile”) may be run that may be displayed (i.e. rendered) on the visualization window 600 along with the geometric object 604. Additional more advanced queries like finding an angle or intersection point between two geometric entities can also be implemented.

The information tag applying module 314 may be configured to apply an information tag (i.e. annotation) corresponding to the query to at least one of: the selected individual geometric object or the selected sub-entity associated with the individual geometric object. For example, if a point is queried for its location, then the same point may be tagged with the coordinates values of its location for easy visual reference. As mentioned earlier, visualization data can also be tagged with other arbitrary information, such as file name and line number of the code being debugged, or the line of code itself to help identify what caused a particular change in the geometry of the entity. For example, as shown in FIG. 4, the visualization window 400 may include, along with the rendering of the geometric object 402, some annotations 404 corresponding to some points associated with the geometric object 402.

The layering module 316 may be configured to group geometric entities in the visualization application into layers. Further, the layering module 316 may be configured to enable turning ON and OFF these layers for visualization. As such, an option may be provided to turn the layers ON and OFF for visualization. This is particularly helpful when debugging code where there are many geometric entities being tracked simultaneously. In such cases, the related geometric entities may be grouped and can be turned ON or OFF to make it easier to visualize other entities in the code.

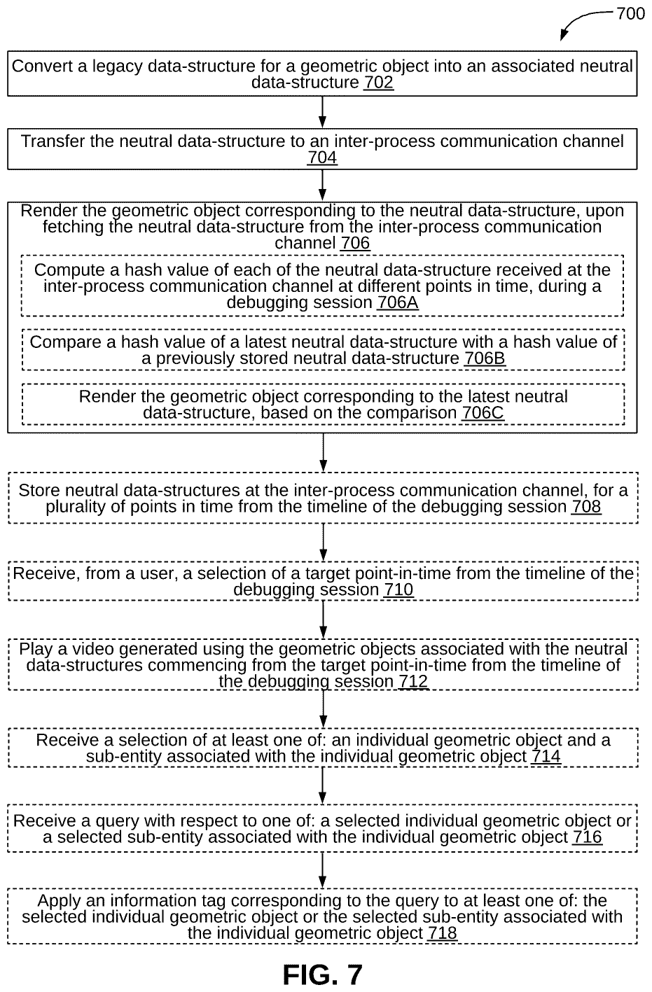

Referring now to FIG. 7, a flowchart of a method 700 of visually inspecting computational geometry code is illustrated, in accordance with some embodiments. The method, for example, may be performed by the code inspecting device 102.

At step 702, a legacy data-structure for a geometric object may be converted into an associated neutral data-structure. The neutral data-structure may be adaptable to be visually rendered. For example, the legacy data-structure for the geometric object is converted into the associated neutral data-structure, using a conversion function.

In an embodiment, the legacy data-structure for the geometric object may be converted periodically into the associated neutral data-structure, at a predefined time interval. For example, the predefined time interval may be 1 second. In another embodiment, a user manipulating a code during a debugging session may be detected. Further, the legacy data-structure for the geometric object may be converted into the associated neutral data-structure, upon detecting the user manipulating the code during the debugging session. At step 704, the neutral data-structure may be transferred to an inter-process communication channel. For example, the inter-process communication channel may be a memory-mapped file.

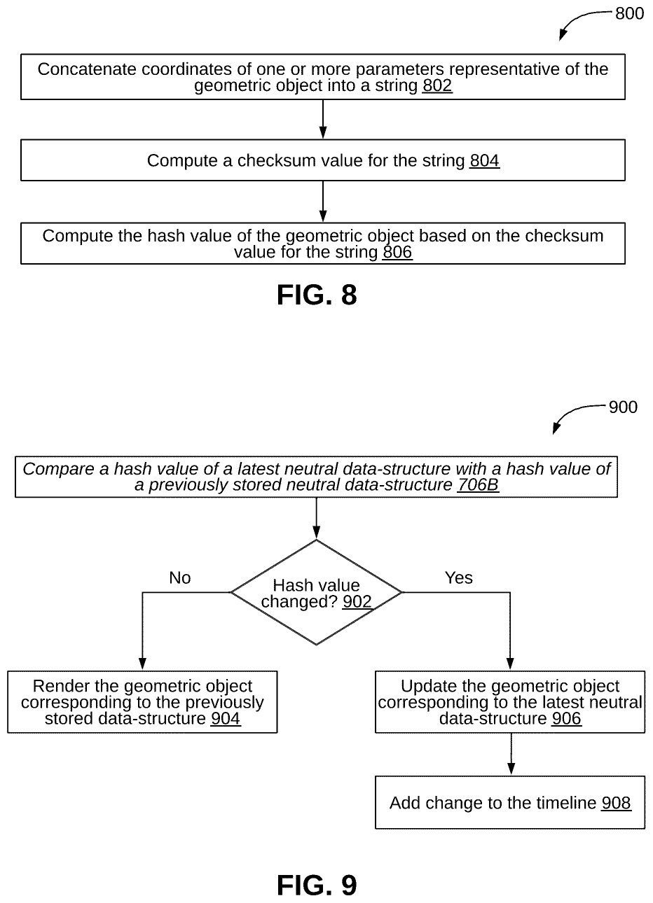

At step 706, the geometric object corresponding to the neutral data-structure may be rendered, upon fetching the neutral data-structure from the inter-process communication channel. For example, the geometric object may be rendered via an independent visualization application. In an embodiment, rendering the geometric object corresponding to the neutral data-structure may further include sub-steps 706A-706C. At step 706A, a hash value may be calculated of each of the neutral data-structure received at the inter-process communication channel at different points in time, during a debugging session. A process of calculating the hash value is explained in conjunction with FIG. 8. At step 706B, a hash value of at latest neutral data-structure may be compared with a hash value of a previously stored neutral data-structure. At step 706C, the geometric object corresponding to the latest neutral data-structure may be rendered, based on the comparison.

Further, in an embodiment, the based on the comparison, for the latest neutral data-structure, the geometric object corresponding to the previously stored data-structure may be rendered, when the hash value of the latest neutral data-structure is same as the hash value of the previously stored neutral data-structure; or However, when the hash value of the latest neutral data-structure is different from the hash value of the previously stored neutral data-structure, the geometric object corresponding to the latest neutral data-structure may be updated. This is further explained in detail in conjunction with FIG. 9.

Additionally, at step 708, neutral data-structures may be stored at the inter-process communication channel, for a plurality of points in time from the timeline of the debugging session. At step 710, a selection of a target point-in-time from the timeline of the debugging session may be received from a user. At step 712, a video generated using the geometric objects associated with the neutral data-structures commencing from the target point-in-time from the timeline of the debugging session may be played.

Further, at step 714, a selection may be received of at least one of: an individual geometric object and a sub-entity associated with the individual geometric object. At step 716, a query may be received with respect to one of: a selected individual geometric object or a selected sub-entity associated with the individual geometric object. At step 718, an information tag may be applied corresponding to the query to at least one of: the selected individual geometric object or the selected sub-entity associated with the individual geometric object.

Referring now to FIG. 8, a flowchart of a method 800 of computing the hash value of each of the neutral data-structure is illustrated, in accordance with some embodiments. At step 802, coordinates of one or more parameters representative of the geometric object may be concatenated into a string. At step 804, a checksum value for the string may be computed. In an example embodiment, the checksum value for the string may be computed using a Fast algorithm. For example, the Fast algorithm may be one of: MD5 or Adler-32. At step 806, the hash value of the geometric object may be computed based on the checksum value for the string.

Referring now to FIG. 9, a flowchart of a method 900 of rendering the geometric object based on change in hash value is illustrated, in accordance with some embodiments. As explained in conjunction with FIG. 7, at step 706B, a hash value of a latest neutral data-structure may be compared with a hash value of a previously stored neutral data-structure.

As step 902, a check may be performed to determine whether the hash value of the latest neutral data-structure has changed with respect to the hash value of the previously stored neutral data-structure or not. If, at step 902, it is determined that the hash value of the latest neutral data-structure has NOT changed with respect to the hash value of the previously stored neutral data-structure, the method 900 may proceed to step 904 (“No” path). At step 904, based on the comparison, for the latest neutral data-structure, the geometric object corresponding to the previously stored data-structure may be rendered (i.e. when the hash value of the latest neutral data-structure is same as the hash value of the previously stored neutral data-structure).

However, if, at step 902, it is determined that the hash value of the latest neutral data-structure has changed with respect to the hash value of the previously stored neutral data-structure, the method 900 may proceed to step 906 (“Yes” path). At step 906, based on the comparison, for the latest neutral data-structure, the geometric object corresponding to the latest neutral data-structure may be updated (when the hash value of the latest neutral data-structure is different from the hash value of the previously stored neutral data-structure). At step 908, a change (corresponding to the update in the geometric object) may be added to the timeline.

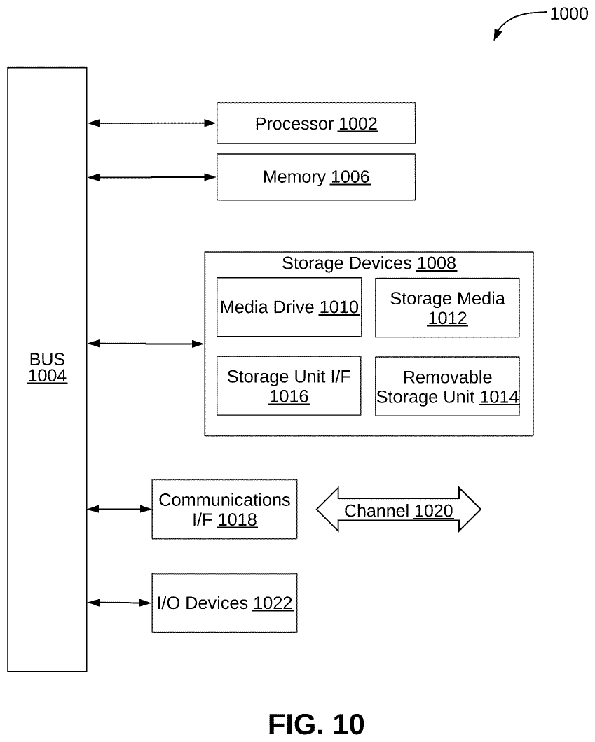

Referring now to FIG. 10, an exemplary computing system 1000 that may be employed to implement processing functionality for various embodiments (e.g., as a SIMD device, client device, server device, one or more processors, or the like) is illustrated. Those skilled in the relevant art will also recognize how to implement the invention using other computer systems or architectures. The computing system 1000 may represent, for example, a user device such as a desktop, a laptop, a mobile phone, personal entertainment device, DVR, and so on, or any other type of special or general-purpose computing device as may be desirable or appropriate for a given application or environment. The computing system 1000 may include one or more processors, such as a processor 1002 that may be implemented using a general or special purpose processing engine such as, for example, a microprocessor, microcontroller or other control logic. In this example, the processor 1002 is connected to a bus 1004 or other communication media. In some embodiments, the processor 1002 may be an Artificial Intelligence (AI) processor, which may be implemented as a Tensor Processing Unit (TPU), or a graphical processor unit, or a custom programmable solution Field-Programmable Gate Array (FPGA).

The computing system 1000 may also include a memory 1006 (main memory), for example, Random Access Memory (RAM) or other dynamic memory, for storing information and instructions to be executed by the processor 1002. The memory 1006 also may be used for storing temporary variables or other intermediate information during the execution of instructions to be executed by processor 1002. The computing system 1000 may likewise include a read-only memory (“ROM”) or other static storage device coupled to bus 1004 for storing static information and instructions for the processor 1002.

The computing system 1000 may also include storage devices 1008, which may include, for example, a media drive 1010 and a removable storage interface. The media drive 1010 may include a drive or other mechanism to support fixed or removable storage media, such as a hard disk drive, a floppy disk drive, a magnetic tape drive, an SD card port, a USB port, a micro-USB, an optical disk drive, a CD or DVD drive (R or RW), or other removable or fixed media drive. A storage media 1012 may include, for example, a hard disk, magnetic tape, flash drive, or other fixed or removable media that is read by and written to by the media drive 1010. As these examples illustrate, the storage media 1012 may include a computer-readable storage medium having stored therein particular computer software or data.

In alternative embodiments, the storage devices 1008 may include other similar instrumentalities for allowing computer programs or other instructions or data to be loaded into the computing system 1000. Such instrumentalities may include, for example, a removable storage unit 1014 and a storage unit interface 1016, such as a program cartridge and cartridge interface, a removable memory (for example, a flash memory or other removable memory module) and memory slot, and other removable storage units and interfaces that allow software and data to be transferred from the removable storage unit 1014 to the computing system 1000.

The computing system 1000 may also include a communications interface 1018. The communications interface 1018 may be used to allow software and data to be transferred between the computing system 1000 and external devices. Examples of the communications interface 1018 may include a network interface (such as an Ethernet or other NIC card), a communications port (such as for example, a USB port, a micro-USB port), Near field Communication (NFC), etc. Software and data transferred via the communications interface 1018 are in the form of signals which may be electronic, electromagnetic, optical, or other signals capable of being received by the communications interface 1018. These signals are provided to the communications interface 1018 via a channel 1020. The channel 1020 may carry signals and may be implemented using a wireless medium, wire or cable, fiber optics, or other communications medium. Some examples of the channel 1020 may include a phone line, a cellular phone link, an RF link, a Bluetooth link, a network interface, a local or wide area network, and other communications channels.

The computing system 1000 may further include Input/Output (I/O) devices 1022. Examples may include, but are not limited to a display, keypad, microphone, audio speakers, vibrating motor, LED lights, etc. The I/O devices 1022 may receive input from a user and also display an output of the computation performed by the processor 1002. In this document, the terms “computer program product” and “computer-readable medium” may be used generally to refer to media such as, for example, the memory 1006, the storage devices 1008, the removable storage unit 1014, or signal(s) on the channel 1020. These and other forms of computer-readable media may be involved in providing one or more sequences of one or more instructions to the processor 1002 for execution. Such instructions, generally referred to as “computer program code” (which may be grouped in the form of computer programs or other groupings), when executed, enable the computing system 1000 to perform features or functions of embodiments of the present invention.

In an embodiment where the elements are implemented using software, the software may be stored in a computer-readable medium and loaded into the computing system 1000 using, for example, the removable storage unit 1014, the media drive 1010 or the communications interface 1018. The control logic (in this example, software instructions or computer program code), when executed by the processor 1002, causes the processor 1002 to perform the functions of the invention as described herein.

One or more techniques for generating recommendations for enhancement of an existing legacy or monolith application are disclosed. The techniques provide for a solution for visualizing different data-types, irrespective of each data-type having their respective representation. As such, the techniques allow developers to visualize geometric entities while debugging to thereby aid in code understanding and maintenance. Further, the techniques are not limited by the IDE extendibility or the programming language. Furthermore, the above techniques provide a two-way communication channel that allows the debugger to post queries and receive corresponding rendering. The techniques are independent of different IDEs and platforms. The techniques help in reducing overall application (code) development time and effort.

It is intended that the disclosure and examples be considered as exemplary only, with a true scope and spirit of disclosed embodiments being indicated by the following claims.

What is claimed is:

1. A method of visually inspecting computational geometry code, the method comprising:
converting a legacy data-structure for a geometric object into an associated neutral data-structure, wherein the neutral data-structure is adaptable to be visually rendered;
transferring the neutral data-structure to an inter-process communication channel; and
rendering the geometric object corresponding to the neutral data-structure, upon fetching the neutral data-structure from the inter-process communication channel.

2. The method of claim 1, wherein the legacy data-structure for the geometric object is converted into the associated neutral data-structure, using a conversion function.

3. The method of claim 1,
wherein legacy data-structure for the geometric object is converted periodically into the associated neutral data-structure, at a predefined time interval, and
wherein the predefined time interval is 1 second.

4. The method of claim 1, wherein converting the legacy data-structure into the associated neutral data-structure comprises:
detecting a user manipulating a code during a debugging session; and
converting the legacy data-structure for the geometric object into the associated neutral data-structure, upon detecting the user manipulating the code during the debugging session.

5. The method of claim 1, wherein the rendering comprises:
computing a hash value of each of the neutral data-structure received at the inter-process communication channel at different points in time, during a debugging session;
comparing a hash value of a latest neutral data-structure with a hash value of a previously stored neutral data-structure; and
rendering the geometric object corresponding to the latest neutral data-structure, based on the comparison.

6. The method of claim 5, wherein the rendering comprises:
based on the comparison, for the latest neutral data-structure,
rendering the geometric object corresponding to the previously stored data-structure, when the hash value of the latest neutral data-structure is same as the hash value of the previously stored neutral data-structure; or
updating the geometric object corresponding to the latest neutral data-structure, when the hash value of the latest neutral data-structure is different from the hash value of the previously stored neutral data-structure.

7. The method of claim 5, wherein the hash value of each of the neutral data-structure is computed by:
concatenating coordinates of one or more parameters representative of the geometric object into a string;
computing a checksum value for the string; and
computing the hash value of the geometric object based on the checksum value for the string.

8. The method of claim 7,
wherein the checksum value for the string is computed using a Fast algorithm,
wherein the Fast algorithm is one of: MD5 or Adler-32.

9. The method of claim 1 further comprising:
storing neutral data-structures at the inter-process communication channel, for a plurality of points in time from a timeline of the debugging session; and
receiving, from a user, a selection of a target point-in-time from the timeline of the debugging session; and
playing a video generated using the geometric objects associated with the neutral data-structures commencing from the target point-in-time from the timeline of the debugging session.

10. The method of claim 1 further comprising:
receiving a selection of at least one of: an individual geometric object and a sub-entity associated with the individual geometric object;
receiving a query with respect to one of: a selected individual geometric object or a selected sub-entity associated with the individual geometric object; and
applying an information tag corresponding to the query to at least one of: the selected individual geometric object or the selected sub-entity associated with the individual geometric object.

11. A system for visually inspecting computational geometry code, the system comprising:
a processor; and
a memory communicatively coupled to the processor, wherein the memory stores a plurality of instructions, which upon execution by the processor, cause the processor to:
convert a legacy data-structure for a geometric object into an associated neutral data-structure, wherein the neutral data-structure is adaptable to be visually rendered;
transfer the neutral data-structure to an inter-process communication channel; and
render the geometric object corresponding to the neutral data-structure, upon fetching the neutral data-structure from the inter-process communication channel.

12. The system of claim 11, wherein the plurality of instructions upon execution by the processor further cause the processor to:
store neutral data-structures at the inter-process communication channel, for a plurality of points in time from a timeline of the debugging session; and
receive, from a user, a selection of a target point-in-time from the timeline of the debugging session; and
play a video generated using the geometric objects associated with the neutral data-structures commencing from the target point-in-time from the timeline of the debugging session.

13. The system of claim 11, wherein the plurality of instructions upon execution by the processor further cause the processor to:
receive a selection of at least one of: an individual geometric object and a sub-entity associated with the individual geometric object;
receive a query with respect to one of: a selected individual geometric object or a selected sub-entity associated with the individual geometric object; and
apply an information tag corresponding to the query to at least one of: the selected individual geometric object or the selected sub-entity associated with the individual geometric object.

14. A non-transitory computer-readable medium storing computer-executable instructions for visually inspecting computational geometry code, the computer-executable instructions configured for:
converting a legacy data-structure for a geometric object into an associated neutral data-structure, wherein the neutral data-structure is adaptable to be visually rendered;
transferring the neutral data-structure to an inter-process communication channel; and
rendering the geometric object corresponding to the neutral data-structure, upon fetching the neutral data-structure from the inter-process communication channel.

15. The non-transitory computer-readable medium of claim 14, wherein converting the legacy data-structure into the associated neutral data-structure comprises:
detecting a user manipulating a code during a debugging session; and
converting the legacy data-structure for the geometric object into the associated neutral data-structure, upon detecting the user manipulating the code during the debugging session.

16. The non-transitory computer-readable medium of claim 14, wherein the rendering comprises:
computing a hash value of each of the neutral data-structure received at the inter-process communication channel at different points in time, during a debugging session;
comparing a hash value of a latest neutral data-structure with a hash value of a previously stored neutral data-structure; and
rendering the geometric object corresponding to the latest neutral data-structure, based on the comparison.

17. The non-transitory computer-readable medium of claim 16, wherein the rendering comprises:
based on the comparison, for the latest neutral data-structure,
rendering the geometric object corresponding to the previously stored data-structure, when the hash value of the latest neutral data-structure is same as the hash value of the previously stored neutral data-structure; or
updating the geometric object corresponding to the latest neutral data-structure, when the hash value of the latest neutral data-structure is different from the hash value of the previously stored neutral data-structure.

18. The non-transitory computer-readable medium of claim 17, wherein the hash value of each of the neutral data-structure is computed by:
concatenating coordinates of one or more parameters representative of the geometric object into a string;
computing a checksum value for the string; and
computing the hash value of the geometric object based on the checksum value for the string.

19. The non-transitory computer-readable medium of claim 14, wherein the computer-executable instructions are further configured for:
storing neutral data-structures at the inter-process communication channel, for a plurality of points in time from a timeline of the debugging session; and
receiving, from a user, a selection of a target point-in-time from the timeline of the debugging session; and
playing a video generated using the geometric objects associated with the neutral data-structures commencing from the target point-in-time from the timeline of the debugging session.

20. The non-transitory computer-readable medium of claim 14, wherein the computer-executable instructions are further configured for:
receiving a selection of at least one of: an individual geometric object and a sub-entity associated with the individual geometric object;
receiving a query with respect to one of: a selected individual geometric object or a selected sub-entity associated with the individual geometric object; and
applying an information tag corresponding to the query to at least one of: the selected individual geometric object or the selected sub-entity associated with the individual geometric object.
